(19) United States
(12) Patent Application Publication
(10) Pub. No.: US 2010/0276644 A1
(43) Pub. Date: Nov. 4, 2010

(54) METHOD FOR PRODUCING NITROGEN-DOPED CARBON NANOTUBES

(75) Inventors: Aurel Wolf, Wulfrath (DE); Volker Michele, Koln (DE); Leslaw Mleczko, Dormagen (DE); Jens Assmann, Hilden (DE); Sigurd Buchholz, Koln (DE)

Correspondence Address: GERSTENZANG, WILLIAM C.;NORRIS MCLAUGHLIN & MARCUS, PA, 875 THIRD AVE, 8TH FLOOR, NEW YORK, NY, 10022, US

(73) Assignee: BAYER TECHNOLOGY SERVICES GMBH, Leverkusen (DE)

(21) Appl. No.: 12/743,721

(22) PCT Filed: Dec. 9, 2008
(86) PCT No.: PCT/EP08/10419

§ 371 Date: May 19, 2010

(30) Foreign Application Priority Data
Dec. 20, 2007 (DE) 10 2007 062 421.4

(51) Int. Cl. H01B 1/04; C01B 31/30; C09K 5/00; H01B 1/12; H01B 1/02

(52) U.S. Cl. 252/512; 423/384; 252/71; 252/74; 252/500; 977/742; 977/753

(57) ABSTRACT

Process for producing nitrogen-doped carbon nanotubes (NCNTs) in a fluidized bed.

The invention relates to a process for producing nitrogen-doped carbon nanotubes (NCNTs) in a fluidized bed.

Carbon nanotubes have become generally known to those skilled in the art at least since their description in 1991 by Iijima (S. Iijima, Nature 354, 56-58, 1991). Since then, the term carbon nanotubes refers to cylindrical bodies comprising carbon and having a diameter in the range from 3 to 80 nm and a length which is a number of times, at least 10 times, the diameter. A further characteristic of these carbon nanotubes are layers of ordered carbon atoms, with the carbon nanotubes generally having a core having a different morphology. Synonyms for carbon nanotubes are, for example, “carbon fibrils” or “hollow carbon fibres” or “carbon bamboos” or (in the case of wound structures) “nanoscrolls” or “nanorolls”.

Owing to their dimensions and their particular properties, these carbon nanotubes are industrially important for the production of composite materials. Further important possibilities are in electronics and energy applications since they generally have a higher specific conductivity than graphitic carbon, e.g. in the form of conductive carbon black. The use of carbon nanotubes is particularly advantageous when these are very uniform in respect of the abovementioned properties (diameter, length, etc).

The possibility of doping these carbon nanotubes with heteroatoms, e.g. atoms of the fifth main group (e.g. nitrogen) during the process for producing the carbon nanotubes in order to obtain basic catalysts is likewise known.

The generally known methods of producing nitrogen-doped carbon nanotubes are based on the conventional production methods for classical carbon nanotubes, for example electric arc, laser ablation and catalytic processes.

Electric arc and laser ablation processes are characterized, inter alia, in that soot, amorphous carbon and fibres having large diameters are formed as by-products in these production processes, so that the resulting carbon nanotubes usually have to be subjected to complicated after-treatment steps, which makes the products obtained from these processes and thus these processes economically unattractive.

In contrast, catalytic processes offer advantages for economical production of carbon nanotubes since a product having a high quality may be able to be produced in good yield by these processes. In the case of the catalytic processes, a distinction is usually made between processes using supported systems and “floating catalyst” processes.

The former usually employ catalysts located on a support matrix which may itself be active, while the latter term usually refers to processes in which the catalyst is formed from a precursor under the reaction conditions for producing the carbon nanotubes.

Maldonado et. al. (Carbon 2006, 44(8), 1429-1437) disclose a typical embodiment of the “floating catalyst” processes according to the prior art. The process for producing nitrogen-doped carbon nanotubes is characterized by the in-situ decomposition of a catalytic component (ferrocene) in the presence of NH₃ and xylene or pyridine. A general disadvantage of such processes is that the use of expensive organometallic chemicals for carrying out such processes is unavoidable. Furthermore, a majority of organometallic chemical compounds are highly hazardous to health or are at least suspected of being carcinogenic.

WO 2005/035841 A2 discloses a process which comprises the production of electrodes comprising a conductive core and a layer of nitrogen-doped carbon nanotubes deposited thereon. The process is a “floating catalyst” process according to the above definition and has the associated disadvantages.

Van Dommele et al. and Matter et al. (S. van Dommele et al., and Surf. Sci. and Cat., 2006, 162, 29-36, ed.: E. M. Gaigneaux et al.; P. H. Matter et al., J. Mol. Cat. A: Chemical 264 (2007), 73-81) each disclose a typical embodiment of supported processes according to the prior art, using nitrogen-doped carbon nanotubes on a supported catalyst comprising cobalt, iron or nickel on an SiO₂ or MgO matrix in order to deposit acetonitrile or pyridine as carbon and nitrogen source thereon in the form of carbon nanotubes. These production processes are characterized, inter alia, in that they are carried out in fixed-bed reactors in the laboratory.

An alternative to these processes is disclosed in US 2007/0157348, in which nitrogen-doped carbon nanotubes are produced catalytically in a fixed bed using an H₂O plasma. The process comprises, inter alia, production of a catalytic metal layer on a substrate surface on which the carbon nanotubes are subsequently formed. This is accordingly a particular embodiment of the supported process variant for producing carbon nanotubes.

The methods just described (supported and “floating catalyst” processes) are also generally known to those skilled in the art under the collective term of catalytic, chemical gas phase deposition (catalytic chemical vapour deposition; CCVD). A characteristic of all CCVD processes is that the metal component which is used and is referred to as catalyst is consumed during the course of the synthesis process. This consumption is generally attributable to deactivation of the metal component, e.g. due to the deposition of carbon on the total particle, which leads to complete covering of the particle (this is known as “encapping” to those skilled in the art).

Reactivation is generally not possible or not economically feasible. Owing to the consumption of catalyst indicated, a high yield of carbon nanotubes based on the catalyst used places substantial demands on catalyst and process. For industrial production of carbon nanotubes, a high space-time yield while maintaining the particular properties of the nanotubes and also minimization of the energy and operating materials employed is sought in all industrial processes.

Processes such as, for example, the previously disclosed processes of Van Dommele et al. and Matter et al. and also of US 2007/0157348 are not advantageous in respect of this objective since they are carried out in fixed-bed reactors and exchange and replacement of any deactivated catalyst is thus possible only with great difficulty. Such supported embodiments are likewise disadvantageous in that the catalytic metal sites available for the reaction of starting material to form nitrogen-doped carbon nanotubes are present only on the surface of the particles or of the substrate. This in turn leads to an inherent limitation of these embodiments in respect of the achievable yield of nitrogen-doped carbon nanotubes per particle or amount of substrate. Furthermore, the types of reactor used are not suitable for long-term continuous operation because of the large change in volume of the fixed bed during carbon nanotube formation. Scale-up of these types of reactor is therefore not possible in an economical fashion.

Processes which are not subject to this restriction are, in particular, fluidized-bed processes. DE 10 2006 017 695 A1 discloses a process which comprises the production of carbon nanotubes in a fluidized bed. In particular, an advantageous mode of operation of the fluidized bed by means of which carbon nanotubes can be produced continuously with introduction of fresh catalyst and discharge of product is disclosed. It is likewise stated that the starting materials used can comprise heteroatoms. Use of starting materials which would lead to nitrogen doping of the carbon nanotubes is not disclosed.

An alternative for achieving high yields based on the catalyst used and for achieving advantageous product properties of carbon nanotubes is disclosed in DE 10 2006 007 147. Here, a catalyst which comprises a high proportion of catalytically active metal components and therefore leads to the desired high yields is disclosed. It is likewise stated that the starting materials used can comprise heteroatoms. Use of starting materials which would lead to nitrogen doping of the carbon nanotubes is not disclosed.

It is therefore an object of the invention to provide a process which makes it possible to produce nitrogen-doped carbon nanotubes and can be scaled up without the advantageous properties of undoped carbon nanotubes according to the prior art, for instance external diameter of from 3 to 150 nm and an aspect ratio L:D>10 (ratio of diameter to lateral dimension), being lost. The process should preferably be able to be operated continuously.

It has surprisingly been found that this object can be achieved by a process for producing nitrogen-doped carbon nanotubes (NCNTs), characterized in that it comprises at least the steps:
a) precipitation of at least one metal (M) from a solution of a metal salt (MS) of the at least one metal (M) in a solvent (L) to give a suspension (S) comprising a solid (F),
b) separation and if appropriate after-treatment of the solid (F) from the suspension (S) to give a heterogeneous metal catalyst (K),
c) introduction of the heterogeneous metal catalyst (K) into a fluidized bed,
d) reaction of at least one starting material (E) comprising carbon and nitrogen or of at least two starting materials (E) of which at least one comprises carbon and at least one comprises nitrogen in the fluidized bed over the heterogeneous metal catalyst (K) to give nitrogen-doped carbon nanotubes (NCNTs),
e) discharge of the nitrogen-doped carbon nanotubes (NCNTs) from the fluidized bed.

The at least one metal (M) used in step a) of the process of the invention usually comprises a transition metal. Preferred metals (M) are the metals (M) selected from the list Fe, Ni, Cu, W, V, Cr, Sn, Co, Mn and Mo. Particularly preferred metals (M) are Co, Mn, Fe and Mo.

The metal salt (MS) of the at least one metal (M) which is usually used in step a) of the process of the invention usually comprises a metal salt (MS) of the at least one metal (M) which is soluble in the solvent (L) (e.g. acetates, nitrates, carbonates and chlorides). Preferred metal salts (MS) of the at least one metal (M) are nitrates, carbonates and chlorides.

Solvents (L) usually used in step a) of the process of the invention encompass short-chain (C₁ to C₆) alcohols, for example methanol, ethanol, n-propanol, i-propanol or butanol, or water and also mixtures thereof. Particular preference is given to water.

The precipitation in step a) of the process of the invention can, for example, be brought about by means of a change in the temperature, the concentration (including by evaporation of the solvent), by means of a change in the pH and/or by addition of a precipitant or combinations thereof.

Preference is given to the precipitation in step a) of the process of the invention being carried out by addition of a precipitant or by means of a combination of above-described embodiments at least using a precipitant. Suitable precipitants are solutions of ammonium carbonate, ammonium hydroxide, urea, alkali metal or alkaline earth metal carbonates and alkali metal or alkaline earth metal hydroxides in the abovementioned solvents. Preference is given to solutions of alkali metal or alkaline earth metal hydroxides.

The precipitation can be carried out batchwise or continuously. Preference is given to continuous precipitation. Particular preference is given to mixing the metal salt solution (MS) of the at least one metal (M) and, if appropriate, the precipitant by means of transport apparatuses in a mixing device having a high mixing intensity. Very particular preference is given to static mixers, Y-mixers, multilamination mixers, valve mixers, micromixers, (two-fluid) nozzle mixers. Further mixers which are similar to these apparatuses and are known to those skilled in the art can likewise be used for this purpose.

In a preferred further development of the step a) according to the invention, surface-active substances (e.g. ionic or nonionic surfactants or carboxylic acids) are added to improve the precipitation behaviour and to modify the surface of the solids produced.

In a likewise preferred further development of the step a) according to the invention, at least one further component (I) which together with the at least one metal (M) forms a catalytically active mixed compound is added.

Possible further components (I) encompass, for example, Mg, Al, Si, Zr, Ti and also further elements which are known to those skilled in the art and form mixed metal oxide and their salts and oxides. Preferred further components (I) are the substances Mg, Al and Si and also their salts and oxides.

Step a) of the process of the invention is particularly preferably carried out so that at least two metal salts (MS) of different metals (M) which are particularly preferred according to the above description are precipitated together with a further component (I) at a pH of greater than 7 by addition of ammonium carbonate, ammonium hydroxide, urea, alkali metal carbonates and hydroxides as precipitant.

The suspension (S) resulting from step a) according to the invention of the process then comprises the solid (F) according to the invention in the solvent (L), with the solid (F) preferably comprising hydroxides and/or carbonates and/or oxides of the metals (M) of the metal salts (MS) used and/or the further components (I) or mixtures of the abovementioned components.

The separation in step b) of the process of the invention is usually carried out with the solid (F) being separated off from the suspension (S) by means of a conventional solid-liquid separation process known to those skilled in the art. As nonexhaustive examples of such processes, mention may be made of filtration, evaporation of the solvent, centrifugation, etc.

The separation in step b) of the process of the invention can be carried out continuously or batchwise. Preference is given to a continuous mode of operation of step b).

In a preferred further development of the separation in step b) of the process of the invention, the separation is carried out in the form of a filtration followed by at least one washing of the solid (F). The washing can be carried out by methods known to those skilled in the art, e.g. membrane processes. Preference is given to carrying out the separation encompassed by the further development in the form of filtration, pressing dry, slurrying, washing and pressing dry. Particular preference is given to carrying out the process steps of slurrying, washing and pressing dry a number of times after the separation in the form of filtration and pressing dry.

In the context of the present invention, slurrying comprises suspending the solid (F) in a solvent (L).

In the context of the present invention, pressing dry comprises pressing liquid out of the suspension of the solid (F) at most until a proportion of liquid in the resulting cake of solid which corresponds to the proportion of capillary water between the particles is achieved. It is therefore distinct from drying in the context of the after-treatment in step b) of the process of the invention.

The separation according to the preferred further development of step b) of the process of the invention can be carried out continuously or batchwise. Particular preference is given to carrying it out continuously. Very particular preference is given to carrying it out continuously using a membrane process for washing.

This further development is particularly advantageous because any salts or other materials carried into step b) of the process of the invention from the precipitation in step a) of the process of the invention can be removed from the solid (F), so that the purity and thus the activity of the heterogeneous metal catalyst (K) can be increased.

Step b) of the process of the invention can be carried out with or without after-treatment of the solid (F) after it has been separated off from the suspension. Preference is given to providing an after-treatment of the solid (F) in order to increase the quality of the subsequent heterogeneous metal catalyst (K).

The after-treatment in the context of step b) of the process of the invention usually comprises at least one drying of the solid (F) and/or calcination of the solid (F). Calcination is only necessary if, after the precipitation in step a) and the separation of the solid (F) in step b), the solid (F) is not in the form of a mixed phase and/or alloy comprising the metals (M), the further component (I) and, if appropriate, oxygen in any ratio.

If an after-treatment in the form of a calcination is provided, this is preferably carried out after drying.

If the solid (F) after the precipitation in step a) and the separation in step b) comprises a mixed phase and/or alloy comprising the metals (M), if appropriate the further component (I) and if appropriate oxygen in any ratio, then this is already the heterogeneous metal catalyst (K) according to the invention which only has to be, if appropriate, after-treated in the form of drying and, if appropriate, by classification, as described below.

The drying in the context of the after-treatment is preferably carried out at temperatures in the range from 150° C. to 250° C. under atmospheric pressure (1013 hPa) in air. Particular preference is given to drying at temperatures of about 180° C. under atmospheric pressure (1013 hPa) in air.

If step b) of the process of the invention is carried out batchwise, drying using a contact dryer (e.g. a paddle dryer) is preferred.

If step b) of the process of the invention is carried out continuously, spray drying is preferred for drying.

Usual residence times of the solid (F) in the drying step in a batchwise after-treatment in the form of drying are in the range from 4 to 18 hours. Preference is given to residence times of about 12 hours.

Usual residence times of the solid (F) in the drying step in continuous after-treatment in the form of drying are in the range from 0.1 to 60 seconds, preferably from 1 to 10 seconds.

The calcination of the solid (F) is usually carried out at temperatures of from about 250° C. to 650° C., preferably at temperatures of from about 300° C. to 600° C. As in the case of drying, calcination is preferably carried out under atmospheric pressure (1013 hPa) in air.

The residence time of the solid (F) in the calcination step is usually in the range from 2 to 12 hours, preferably about 4 hours.

If calcination is to be carried out continuously, it can occur, for example, in a different fluidized bed than that of step c) of the process of the invention or in a rotary tube furnace, tunnel kiln, moving-bed reactor or similar apparatuses known to those skilled in the art. A person skilled in the art will generally know how such an apparatus has to be configured in each individual case.

The resulting heterogeneous metal catalyst (K) preferably comprises a mixture and/or alloy of the form M₁:M₂:I₁:I₂O, with the constituents M₁, M₂ comprising the metals (M) according to the invention and the constituents I₁ and I₂O comprising the oxides of at least parts of the preferred further components (I). At the same time, the above representation refers to proportions by mass of the constituents of the resulting heterogeneous metal catalyst (K) which add up to 100%. Particular preference is given to M₁ being Mn and the proportion by mass in the above representation being from 2 to 65%. Particular preference is likewise given to M₂ being Co and the proportion by mass being from 2 to 80%. Preference is likewise given to I₁₀ being Al₂O₃ and the proportion by mass being from 5 to 75%. Preference is likewise given to I₂O being MgO and the proportion by mass being from 5 to 70%.

Very particular preference is given to heterogeneous metal catalysts (K) which have similar proportions by mass of Mn and Co. In this case, preference is given to an Mn/Co ratio of from 2:1 to 1:2, particularly preferably from 1.5:1 to 1:1.5.

The resulting heterogeneous metal catalyst (K) likewise preferably comprises particles having an external diameter in the range from 20 μm to 1500 μm, particularly preferably an external diameter of the particles in the range from 30 μm to 600 μm, very particularly preferably from 30 μm to 100 μm. The particle size distribution can in this case be measured by means of, for example, laser light scattering or by sieving.

A person skilled in the art will know methods of controlling particle sizes in the precipitation. This can, for example, be achieved by means of a sufficiently long residence time in the precipitation bath.

Should the heterogeneous metal catalyst (K) have a fraction of the particle size distribution which is larger than the desired range, the after-treatment additionally comprises classification in a preferred further development of step b) according to the invention of the process of the invention. Possible classification methods are known to those skilled in the art, for example sieving or sifting.

The fraction of excessively large particles obtained after classification is, in a particularly preferred further development of step b) according to the invention of the process of the invention, subjected to comminution and classified again.

The classification and in particular the comminution with further classification according to the preferred further development is advantageous because the specific catalytic surface area of the heterogeneous metal catalyst compared to the particle size which can ideally be used for process engineering reasons can be optimized in this way. Relatively small particles tend to agglomerate or form dust, which is disadvantageous from a process engineering point of view, while relatively large particles have a lower specific surface area and are thus disadvantageous in terms of the desired space-time yield of the process of the invention.

The process of the invention and its preferred embodiments and further developments up to step b) are particularly advantageous because the coprecipitation of any further component (I) used and at least one metal (M) and the after-treatment can be controlled so that the porosity of the resulting heterogeneous metal catalysts (K) and the morphology of the catalytically active sites of the at least one metal (M) on the surface of the heterogeneous metal catalyst (K) is set so that the nitrogen-doped carbon nanotubes can be obtained in high yield and with a small size distribution around the desired size.

The heterogeneous metal catalyst (K) thus has a porous structure whose surface has catalytically active sites of the at least one metal (M). A higher yield of the nitrogen-doped carbon nanotubes per amount of heterogeneous metal catalyst (K) used can therefore be achieved using the heterogeneous metal catalyst (K) according to the invention since the interior of the porous heterogeneous metal catalysts (K) is also accessible to the starting material.

As is known in the case of heterogeneous catalysts, conditioning of the heterogeneous metal catalyst (K) can be advantageous as further after-treatment. This conditioning comprises, for example, treatment with reactive atmospheres or, for example, steam with the aim of improving the catalytic properties. The conditioning can be preceded or followed by shaping and/or classification. In particular cases, conditioning of the heterogeneous catalyst (K) with a reactive gas such as hydrogen, hydrocarbons, CO or mixtures of the gases mentioned can be advantageous in order to obtain a particularly reactive heterogeneous metal catalyst (K). Such conditioning enables the oxidation state of the metal compounds present in the heterogeneous metal catalyst (K) to be altered but also enables the morphology of the resulting catalyst structure to be influenced. Preference is given to the direct use of the catalyst, reductive conditioning or else conditioning in the form of a complete or partial conversion of the metal compounds present in the heterogeneous metal catalyst (K) into the corresponding carbides.

The introduction of the heterogeneous metal catalysts (K) into the fluidized bed in step c) of the process of the invention can be effected continuously or batchwise. Continuous introduction of the heterogeneous metal catalyst (K) into the fluidized bed is preferred. The heterogeneous metal catalyst (K) can be reduced as described before introduction, be added in an oxidic form of the metals (M) or even be added in the form of the precipitated hydroxides or carbonates.

The fluidized bed used in steps c) to e) of the process of the invention can comprise a reaction space containing a bubble-forming fluidized bed, turbulent fluidized bed or a fluidized bed through which jets of gas pass, with internally or externally circulating fluidized beds being able to be used. It is also possible to introduce the heterogeneous metal catalyst (K) into a fluidized bed which is already filled with particles. These particles can be inert particles and/or consist entirely or partly of a further heterogeneous metal catalyst (K). These particles can also be agglomerates of carbon nanotubes or nitrogen-doped carbon nanotubes.

The fluidized bed used for carrying out the process can comprise a suitable highly heat-resistant steel or material which is inert in respect of catalytic effects, e.g. graphite or fused silica. These materials are used because of the particular demands placed on the materials by the conditions in the reaction zone comprising the fluidized bed according to the invention.

The reaction in step d) according to the invention of the process is usually carried out using at least one starting material (E) comprising carbon and nitrogen or using at least two starting materials (E) of which at least one comprises carbon and at least one comprises nitrogen. The reaction is preferably carried out using at least one starting material (E) comprising carbon and nitrogen. The reaction is particularly preferably carried out using at least one starting material (E) comprising a nitrogen-containing organic compound which is present in gaseous form under the conditions in the reaction zone described below. The reaction is very particularly preferably carried out using at least one starting material (E) selected from the list acetonitrile, dimethylformamide, acrylonitrile, propionitrile, butyronitrile, pyridine, pyrrole, pyrazole, pyrrolidine and piperidine.

Preference is likewise given to using, in addition to the at least one starting material (E) comprising carbon and nitrogen, a further starting material (E) which does not contain any nitrogen. Preference is given to a further starting material (E) selected from the list methane, ethane, propane, butane and higher aliphatics which are present in gaseous form under the conditions in the reaction zone described below and also ethylene, propylene, butene, butadiene and higher olefins which are present in gaseous form under the conditions in the reaction zone described below, acetylene or aromatic hydrocarbons which are present in gaseous form under the conditions in the reaction zone described below.

In the fluidized bed according to the invention, there is a reaction zone for carrying out the reaction as per step d) of the process of the invention, which reaction zone is characterized by a reaction temperature according to the invention, a reaction pressure according to the invention and a gas velocity according to the invention of the gases introduced.

The gases introduced can comprise the at least one starting material (E) according to the invention in the gas phase and also further gases. Further gases preferably comprise hydrogen and/or inert gases. Inert gases preferably comprise noble gases or nitrogen.

The composition of the mixture of the gases introduced into the reaction zone is usually 0-90% by volume of hydrogen, 0-90% by volume of an inert gas such as nitrogen or argon and 5-100% by volume of the at least one starting material (E) in the gaseous state, preferably 0-50% by volume of hydrogen, 0-80% by volume of an inert gas such as nitrogen or argon and 10-100% by volume of the at least one starting material (E) in the gaseous state, particularly preferably 0-40% by volume of hydrogen, 0-50% by volume of an inert gas such as nitrogen or argon and 20-100% by volume of the at least one starting material (E) in the gaseous state.

The at least one starting material (E) can, in order to be present in gaseous form in the reaction zone, be vaporized by means of an apparatus generally known to those skilled in the art, e.g. a heat exchanger, before introduction into the fluidized bed according to the invention or be fed in another state of matter into the fluidized bed and vaporized in the fluidized bed before entry into the reaction zone.

The gas stream comprising the at least one starting material (E) can be introduced directly or, according to a preferred further development of step d) of the process of the invention, in preheated form into the fluidized bed and/or the reaction zone of the fluidized bed. The gas stream comprising the at least one starting material (E) is preferably preheated to from 25° C. to 300° C., particularly preferably from 200° C. to 300° C., before entry into the fluidized bed and/or the reaction zone of the fluidized bed. The apparatuses to be used for this purpose are generally known to those skilled in the art.

The temperature according to the invention in the reaction zone in which the reaction as per step d) of the process of the invention is carried out is usually in the range from 300° C. to 1600° C., preferably from 500° C. to 1000° C., particularly preferably from 600° C. to 850° C.

A temperature which is too low generally leads to slow reaction rates, so that the objective according to the invention of a high space-time yield can sometimes not be achieved. A temperature which is too high generally leads to spontaneous pyrolysis of the gaseous at least one starting material (E), so that it may no longer be able to be converted over the heterogeneous metal catalyst (K) into the product, viz. the nitrogen-doped carbon nanotubes.

The pressure according to the invention in the reaction zone in which the reaction as per step d) of the process of the invention is carried out is usually in the range from 0.05 bar to 200 bar, preferably from 0.1 bar to 100 bar, particularly preferably from 0.2 bar to 10 bar.

The pressures according to the invention and preferred pressures together with the above-mentioned temperatures according to the invention and preferred temperatures produce conditions in the reaction zone which usually allow all and in particular the preferred starting materials (E) to be present in the gas phase. Should the at least one starting material (E) not be, as described above, introduced in the gas phase into the fluidized bed, it is necessary either to provide a vaporization zone in the fluidized bed having these conditions upstream of the reaction zone or to operate the above-described apparatus for the vaporization of the at least one starting material (E) under, for example, these conditions.

The fluidized bed of the process of the invention is usually operated in step d) so that, at least in the reaction zone, the gas velocity is set so that it is from 1.1 to 60 times the minimum fluidization velocity for all particles present in the fluidized bed. It is preferably from 2 to 30 times, particularly preferably from 5 to 20 times, the minimum fluidization velocity. Furthermore, the gas velocity is preferably set so as to be smaller than the settling velocity of each individual particle in the fluidized bed.

A gas velocity which is too high leads to the discharge of relatively fine agglomerate particles and in particular of the catalyst which has undergone little or no reaction. Gas velocities which are too low result in defluidization of relatively large agglomerates and accordingly undesirable caking of the contents of the reactor.

Minimum fluidization velocity is a term known to those skilled in the art in connection with the operation of fluidized beds and is comprehensively described in the literature (Daizo Kunii, Octave Levenspiel, “Fluidization Engineering”, 2nd Edition, Butterworth-Heinemann Boston, London, Singapore, Sydney, Toronto, Wellington 1991). Methods of determining this minimum fluidization velocity are likewise known to those skilled in the art. The minimum fluidization velocity is distinct from the settling velocity of an individual particle. A person skilled in the art will know the theoretical background to this distinction. However, to give a better understanding, it may be said that the settling velocity of an individual particle is greater than the minimum fluidization velocity of a bed of these individual particles.

The determination of each of these velocities is possible because the particle sizes of the heterogeneous metal catalyst (K) are set according to the process of the invention or one of its preferred variants.

Operation of the fluidized bed or at least the reaction zone of the fluidized bed under the conditions or gas velocity just described is advantageous because it enables discharge of individual particles from the fluidized bed to be avoided and at the same time enables intensive mixing and thus contacting of the gas stream comprising the at least one gaseous starting material (E) with the solid to be ensured, which in turn results in maximum conversions over the heterogeneous metal catalyst (K) according to the invention. Since the distribution of the particle properties relevant to fluidization, e.g. particle density and diameter, is particularly broad in the case of the heterogeneous metal catalysts (K) which are used in the process of the invention and give a high specific yield of nitrogen-containing carbon nanotubes (product mass produced per mass of catalyst added), it is particularly advantageous to carry out the process according to the embodiments just described.

As an alternative to adhering to the requirement that the gas velocity be set so that it is lower than the settling velocity of each individual particle, an apparatus for recirculating discharged particles, e.g. a cyclone, can be installed downstream of the fluidized bed. This can also occur in addition to the abovementioned requirement in order to be able to prevent discharge in the event of an operational malfunction.

According to the embodiments according to the invention and preferred embodiments of step d) of the process, the nitrogen-doped carbon nanotubes (NCNTs) according to the invention are then formed on the heterogeneous metal catalyst (K), as a result of which the particles of the heterogeneous metal catalyst (K) are, according to the invention, broken up and agglomerate particles of nitrogen-doped carbon nanotubes (NCNTs) and residues of the heterogeneous metal catalyst (K) are formed.

The discharge of the nitrogen-doped carbon nanotubes (NCNTs) in step e) of the process of the invention is usually carried out in such a way that those agglomerate particles of the nitrogen-doped carbon nanotubes (NCNTs) which have reached the intended maximum agglomerate diameter are removed from the fluidized bed.

The discharge in step e) of the process of the invention can be carried out batchwise or continuously. The batchwise embodiment of step e) of the process of the invention can be carried out by simple taking-off from the fluidized bed after the growth time has elapsed by means of a suitable discharge device. Here, the introduction of the gas stream comprising the at least one starting material (E) into the fluidized bed may have been stopped beforehand.

However, the discharge as per step e) of the process of the invention is preferably carried out continuously. Particular preference is given to step e) being carried out continuously and the fluidized bed being provided with a screening discharge device. Such devices are generally known to those skilled in the art, e.g. as sieves, with recirculation of the fines to the fluidized bed and the reaction zone of the fluidized bed likewise having to be provided. Such a device ensures that only agglomerates having a diameter above a chosen maximum diameter are discharged from the reactor and smaller particles remain in the reactor.

Such a device can be installed internally in the fluidized bed or be arranged externally outside the fluidized bed and be connected to the latter via a transport circuit. It can be made up of, for example, suitable sieves or air classification, e.g. by means of a zig-zag classifier, can be carried out.

The continuous embodiment using a screening device is particularly advantageous because it is in this way possible to ensure a constant product quality based on yield and residual content of heterogeneous metal catalyst (K) of the nitrogen-doped carbon nanotubes (NCNTs).

The overall process of the invention and its preferred embodiments make possible, in a surprisingly advantageous manner, the continuous, heterogeneously catalyzed production of nitrogen-doped carbon nanotubes (NCNTs) in a fluidized bed. In particular, a surprisingly advantageous embodiment for producing a heterogeneous metal catalyst (K) by continuous precipitation from metal salt solutions (MS) in combination with further process steps for achieving tailored properties for the subsequent reaction step in a fluidized bed (see above: setting of the particle size and also suitable treatment) to form the nitrogen-doped carbon nanotubes (NCNTs) produced has been found.

Furthermore, it has surprisingly been found that the heterogeneous metal catalyst (K) produced by the process of the invention displays, in subsequent use, no formation of nitrides and thus no loss of the catalytic activity for producing the nitrogen-doped carbon nanotubes (NCNTs). As a result, it is possible to obtain, inter alia, the yields of nitrogen-doped carbon nanotubes (NCNTs) per amount of heterogeneous metal catalyst (K) used as disclosed in the later examples.

In its totality, the process presented here makes it possible to produce nitrogen-doped carbon nanotubes (NCNTs) in high yield based on the mass of catalyst used combined with very good quality and a high proportion of graphitic material, with these carbon nanotubes at the same time having a very narrow distribution of the geometric dimensions.

As further advantage of the process of the invention, mention may be made of its simple scale-up since all embodiments of the process steps of the process disclosed can be carried out continuously in a simple fashion by means of apparatuses which can easily be scaled up by a person skilled in the art.

The nitrogen-doped carbon nanotubes (NCNTs) produced by the process of the invention and its preferred variants can virtually always be used without further work-up because of the low content of heterogeneous metal catalyst (K).

If a work-up is nevertheless desired, the nitrogen-doped carbon nanotubes (NCNTs) can be purified further using methods which are generally known for this purpose to those skilled in the art (e.g. by chemical dissolution of the residues of catalyst and support, by oxidation of the amorphous carbon formed in very small amounts or by thermal after-treatment in an inert or reactive gas).

It is likewise possible to subject the carbon nanotubes produced to chemical functionalization in order to obtain, for example, improved bonding into a matrix or match the surface properties to the desired use in a targetted manner.

The nitrogen-doped carbon nanotubes (NCNTs) produced according to the invention can be used as additives in many materials, for mechanical reinforcement, for increasing the electrical conductivity, colouring, increasing the flame resistance.

Preference is given to using the nitrogen-doped carbon nanotubes (NCNTs) produced according to the invention in polymers, ceramics or metals as constituent of a composite for improving the electrical and/or thermal conductivity and/or mechanical properties.

Preference is likewise given to using the nitrogen-doped carbon nanotubes (NCNTs) produced according to the invention for producing conductor tracks and conductive structures.

Particular preference is given to use in batteries, capacitors, VDUs (e.g. flat VDUs) or lighting devices and also as field effect transistors.

Other uses of the nitrogen-doped carbon nanotubes (NCNTs) produced according to the invention include use as storage medium, e.g. for hydrogen or lithium, in membranes, e.g. for the purification of gases, as catalyst or as support material, e.g. for catalytically active components in chemical reactions, in fuel cells, in the medical sector, e.g. as framework for the control of growth of cell tissue, in the diagnostic sector, e.g. as marker, and also in chemical and physical analysis (e.g. in atomic force microscopes).

The process of the invention and the catalysts used according to the invention are illustrated below with the aid of some examples, but the examples do not constitute a restriction of the scope of the invention.

### EXAMPLES

### Production of a Catalyst According to the Invention

### Example 1

Four solutions of 947.3 g of Co(NO₃)₂.6H₂O in 2441.4 ml of deionized water, 830.1 g of Mn(NO₃)₂.4H₂O in 2441.4 ml of deionized water, 1757.8 g of Al(NO₃)₃.9H₂O in 1709 ml of deionized water and 1494.1 g of Mg(NO₃)₂.6H₂O in 1709 ml of deionized water were produced. The Mn- and Co-containing solutions and the Al- and Mg-containing solutions were in each case combined and stirred at room temperature for 5 minutes. The two solutions obtained were subsequently likewise combined and stirred for 5 minutes. Any turbidity was dissolved by dropwise addition of dilute HNO₃. The solution obtained in this way will hereinafter be referred to as solution A. A solution referred to below as solution B was produced by stirring 1464.8 g of NaOH into 4882.8 ml of deionized water. At room temperature, the two solutions A and B were conveyed by means of pumps through a valve mixer so that intensive continuous mixing was ensured. The stream of suspension obtained was collected in a vessel containing an initial charge of about 500 ml of deionized water with stirring, while maintaining the pH at 10. The volume flow of the solution A was 2.8 l/h. The volume flow of the solution B was continually adjusted so as to ensure a constant pH. The solid obtained in this way was filtered off and subsequently washed free of NaOH by means of displacement washing. The filter cake was dried overnight at 180° C. in air and subsequently calcined at 400° C. in air for 4 hours. Calcination gave 1046.9 g of a black solid. The theoretical ratio of the components used is Mn:Co:Al₂O₃:MgO=17:18:44:21.

### Example 2

Four solutions of 863.4 g of Co(NO₃)₂.6H₂O in 1439 ml of deionized water, 736.8 g of Mn(NO₃)₂.4H₂O in 1439 ml of deionized water, 264.8 g of Al(NO₃)₃.9H₂O in 575.6 ml of deionized water and 230.2 g of Mg(NO₃)₂.6H₂O in 431.7 ml of deionized water were produced. The Mn- and Co-containing solutions and the Al- and Mg-containing solutions were in each case combined and stirred at room temperature for 5 minutes. The two solutions obtained were subsequently likewise combined and stirred for 5 minutes. Any turbidity was dissolved by dropwise addition of dilute HNO₃. The solution obtained in this way will hereinafter be referred to as solution A. A solution referred to below as solution B was produced by stirring 544.3 g of NaOH into 2099.3 ml of deionized water. At room temperature, the two solutions A and B were conveyed by means of pumps through a valve mixer so that continuous mixing was ensured. The stream of suspension obtained was collected in a vessel containing an initial charge of about 500 ml of deionized water with stirring, while maintaining the pH at 10. The volume flows of the solutions A and B were 2.8 l/h and about 1.5 l/h, respectively. The volume flow of the solution B was continually adjusted so as to ensure a constant pH. The solid obtained in this way was filtered off and subsequently washed free of NaOH by means of displacement washing. The filter cake was dried overnight at 180° C. in air and subsequently calcined at 400° C. in air for 4 hours. Calcination gave 550 g of a black solid. The theoretical ratio of the components used is Mn:Co:Al₂O₃:MgO=36:39:16:9.

Production of nitrogen-containing carbon nanotubes 4 examples of the production of nitrogen-doped carbon nanotubes by the process of the invention are presented below. All relevant experimental parameters are shown in Table 1; Example 5 (catalyst having a low loading, no addition of ethylene to the feed gas) is described in detail here.

### Example 5

24 g of catalyst 1 from Example 1 are introduced into a fluidized-bed reactor which is made of high-temperature-resistant stainless steel and has an internal diameter of 100 mm and in which an initial charge of 350 g of nitrogen-containing carbon nanotube agglomerates is already present. The catalyst particles have a diameter in the range from 32 μm to 90 μm. The reactor is electrically heated from the outside to a reaction temperature of 750° C. and, after the reactor has been made inert, the reaction mixture consisting of 15 g/min of acetonitrile, 25 standard 1/min of nitrogen and 3.6 standard 1/min of hydrogen are fed into the apparatus through a perforated plate at the lower end of the reactor. The superficial gas velocity at the lower end of the reactor under operating conditions is 0.27 m/s. The feed gas mixture is produced in an upstream electrically heated fixed bed (diameter: 50 mm, height: 1000 mm, packed with glass Raschig rings); the acetonitrile is metered in liquid form into this by means of a metering pump; the nitrogen and the hydrogen are introduced in gaseous form into the evaporating acetonitrile so that a superheated gas mixture leaves the fixed bed at a temperature of about 200° C. and enters the fluidized-bed reactor. Nitrogen-doped carbon nanotubes are formed on the initially charged catalyst in the fluidized bed, as a result of which the catalyst particles are broken up and the agglomerate particles of nitrogen-doped carbon nanotubes and catalyst residues are formed. The feed gases are supplied to the catalyst for a period of 90 minutes until the catalyst has been completely deactivated; the activity of the catalyst is monitored via the hydrogen evolution in the reactor determined by means of gas chromatography. After the reactor has been made inert by means of nitrogen, 220 g of a black powder are taken from the reactor and a further about 350 g of product remain in the reactor as initial charge for the next batch. The structure and morphology of the nitrogen-doped carbon nanotubes deposited were determined by means of TEM analyses (instrument from FEI, model: Tecnai20, Megaview III; method as specified by the manufacturer). The amount of nitrogen incorporated is determined by means of ESCA analysis (instrument from ThermoFisher, ESCALab 2201XL; method as specified by the manufacturer). The content of nitrogen based on catalyst used, hereinafter referred to as yield, was defined on the basis of the mass of catalyst after calcination (m_{cat,0}) and the weight increase after reaction (mₜₒₜₐₗ−m_{cat,0}): yield=(mₜₒₜₐₗ−m_{cat,0})/M_{cat,0}. In the case of Example 5 examined in detail here, a yield of 8.2 g of NCNT/g of cat. is achieved and the nitrogen content of the product is 4.28% by weight.

Table 1 shows further examples which were otherwise carried out in a manner analogous to Example 5 described in detail above. It can be seen that catalysts based on Mn—Co—Al—Mg compounds give a high yield of nitrogen-doped carbon nanotubes based on the amount of catalyst used. The yield of nitrogen-doped carbon nanotubes based on the amount of catalyst used can be increased by addition of ethylene as additional carbon donor to the feed gas, but the nitrogen content of the product taken from the reactor then decreases.

TABLE 1
Overview of experiments for catalyst testing in a fluidized-bed apparatus

| | | | | | Ethylene | | | | |
|---|---|---|---|---|---|---|---|---|---|
| | | | | Acetonitrile | in the | H₂ in the | N₂ in the | Yield in | Nitrogen |
| | Catalyst | | | in the feed | feed gas | feed gas | feed gas | g of | content of |
| | from | Catalyst composition | T | gas | standard | standard | standard | NCNT/ | product |
| Example | example | wt % | ° C. | g/min | l/min | l/min | l/min | g of cat | wt % |
| 3 | 1 | Mn:Co:Al₂O₃:MgO | 750 | 3.9 | 33 | 0 | 3.3 | 33.5 | 0.51% |
| | | 17:18:44:21 | | | | | | | |
| 4 | 1 | Mn:Co:Al₂O₃:MgO | 750 | 15.3 | 33 | 0 | 3.3 | 17.4 | 0.84% |
| | | 17:18:44:21 | | | | | | | |
| 5 | 1 | Mn:Co:Al₂O₃:MgO | 750 | 15.0 | 0 | 3.6 | 25 | 8.2 | 5.74% |
| | | 17:18:44:21 | | | | | | | |
| 6 | 2 | Mn:Co:Al₂O₃:MgO | 750 | 17.2 | 0 | 3.6 | 25 | 9.3 | 5.42% |
| | | 36:39:16:9 | | | | | | | |

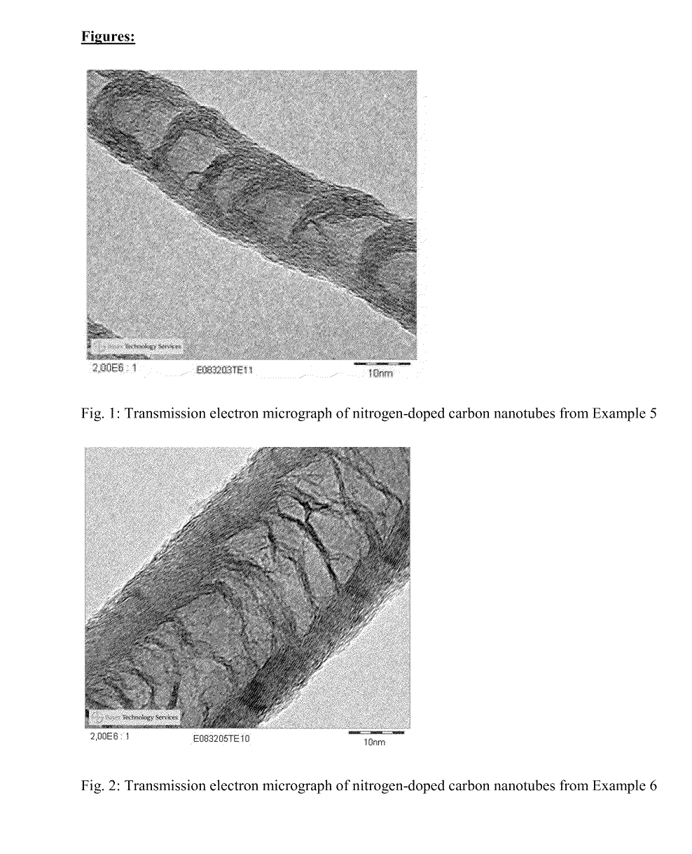

FIG. 1 shows a transmission electron micrograph of nitrogen-doped carbon nanotubes from Example 5

FIG. 2 shows a transmission electron micrograph of nitrogen-doped carbon nanotubes from Example 6

1. Process for producing nitrogen-doped carbon nanotubes (NCNTs), comprising at least the steps of
a. precipitating at least one metal (M) from a solution of a metal salt (MS) of at least one metal (M) in a solvent (L) to give a suspension (S) comprising a solid (F),
b. separating and optionally after-treating the solid (F) from the suspension (S) to obtain a heterogeneous metal catalyst (K),
c. introducing the heterogeneous metal catalyst (K) into a fluidized bed,
d. reacting at least one starting material (E) comprising carbon and nitrogen or of at least two starting materials (E) of which at least one comprises carbon and at least one comprises nitrogen in the fluidized bed over the heterogeneous metal catalyst (K) to produce nitrogen-doped carbon nanotubes (NCNTs),
e. discharging of the nitrogen-doped carbon nanotubes (NCNTs) from the fluidized bed.

2. Process according to claim 1, wherein the at least one metal (M) comprises a transition metal.

3. Process according to claim 1 wherein the metal salt (MS) comprises a metal salt (MS) of the at least one metal (M) which is soluble in the solvent (L).

4. Process according to claim 1, wherein the precipitation in step a) is carried out by addition of a precipitant.

5. Process according to claim 1, wherein at least one further component (I) which together with the at least one metal (M) forms a catalytically active mixed compound is added in the precipitation in step a).

6. Process according to claim 1, wherein the separation in step b) is carried out in the form of a filtration which is followed by at least one washing of the solid (F).

7. Process according to claim 1, further comprising an after-treatment of the solid.

8. Process according to claim 7, wherein the after-treatment in step b) comprises at least one drying of the solid (F) and/or a calcination of the solid (F).

9. Process according to claim 1, wherein the heterogeneous metal catalyst (K) comprises a mixture and/or alloy of the form M₁:M₂:I₁:I₂O.

10. Process according to claim 9, wherein M₁ is Mn and is present in a proportion by mass of from 2 to 65% and M₂ is Co and is present in a proportion by mass of from 2 to 80% and I₁₀ is Al₂O₃ and is present in a proportion by mass of from 5 to 75% and I₂O is MgO and is present in a proportion by mass of from 5 to 70%.

11. Process according to claim 1, wherein the heterogeneous metal catalyst (K) comprises particles having an external diameter in the range from 20 μm to 1500 μm.

12. Process according to claim 1, wherein the reaction in step d) is carried out at temperatures in the range from 300° C. to 1600° C.

13. Process according to claim 1, wherein the gas velocity in the fluidized bed in of step d), at least in the reaction zone, is from 1.1 to 60 times the minimum fluidization velocity of all particles present in the fluidized bed.

14. A method for improving the electrical and/or thermal conductivity and/or mechanical properties of polymers, ceramics or metals which comprises forming a composite of said polymers, ceramics or metals with nitrogen-doped carbon nanotubes produced by the process of claim 1.

15. A method for producing conductor tracks and/or conductive structures, which comprises producing said conductor tracks and/or conductive structures with the nitrogen-doped carbon nanotubes of claim 1.
